(19) United States
(12) Patent Application Publication
(10) Pub. No.: US 2024/0327685 A1
(43) Pub. Date: Oct. 3, 2024

(54) COMPOSITION USABLE AS TEMPORARY FIXATIVE

(71) Applicant: Heraeus Electronics GmbH & Co. KG, HANAU (DE)

(72) Inventors: Tanja DICKEL, Hanau (DE); Yvonne LÖWER, Hanau (DE); Lukas HUBER, Lahntal (DE)

(21) Appl. No.: 18/576,653

(22) PCT Filed: Mar. 3, 2022
(86) PCT No.: PCT/EP2022/055341

§ 371 Date: Jan. 4, 2024

(30) Foreign Application Priority Data
Jul. 9, 2021 (DE) 10 2021 207 267.4

(51) Int. Cl. C09J 133/10; C09J 11/04; C09J 11/06

(52) U.S. Cl. CPC C09J 133/10; C09J 11/04; C09J 11/06; C09J 2203/326; C09J 2433/00

(57) ABSTRACT

A composition consisting of:
(A) 20% to 30% by weight of one or more thermoplastic polymers,
(B) 45% to 69% by weight of organic solvent,
(C) 2% to 15% by weight of silica particles,
(D) 0.5% to 10% by weight of organic thickener,
(E) 1% to 10% by weight of particulate inorganic filler having a Mohs hardness in the range from 1 to 8, and
(F) 0% to 1% by weight of one or more constituents other than constituents (A) to (E).

The invention relates to a composition which can be used as a temporary fixative in the electronics field.

Compositions usable as temporary fixatives (prefixing agent) in the electronics field are known from the patent literature, for example from EP 3 276 652 A2, WO 2017/060140 A2 and WO 2019/170213 A1. They can serve for temporarily fixing (prefixing) an arrangement, which is not yet firmly connected, consisting of one or more electronic components with one or more solder preforms or sinter preforms. An arrangement which is temporarily fixed in this way can subsequently be firmly connected by appropriate heat or temperature treatment, i.e. by soldering or by sintering, respectively. For example, a temporary fixative can serve for temporarily fixing a solder preform to be converted into a solder deposit or for temporarily fixing a sinter preform on an electronic component or for temporarily fixing solder preforms or sinter preforms between electronic components. However, they can also serve for the temporary fixing of an electronic component on a solder deposit of a further electronic component equipped therewith. The heat or temperature treatment of the temporarily fixed arrangement usually takes place in a furnace. In the case of a temporarily fixed arrangement comprising a sinter preform, the furnace can be, for example, a pressure sintering furnace, in the case of a temporarily fixed arrangement comprising a solder preform or a solder deposit, for example a reflow oven.

Finally, the temporary fixative can also serve, for example, to equip a solder deposit located on an electronic component with temporary fixative on its outwardly facing free contact surface.

Herein, the term “firmly connected arrangement” is used. This means a mechanically firmly connected arrangement. The mechanically firm metal connection is of course also electrically conductive. In other words, the firmly connected contact surfaces of the arrangement are connected not only mechanically firmly, but also electrically conductively.

The term “solder preform” used herein refers to solder metal in the form of a molded part, for example solder metal foil, solder metal strip, solder metal platelets or solder metal cylinders. Solder preforms have discrete contact surfaces, for example contact surfaces arranged on opposite sides of a solder preform. The thickness of a solder preform can be for example in the range of 10 to 750 μm.

Solder or solder metal is, for example, tin or tin-rich alloys. Examples of tin-rich alloys are those having a tin content for example in the range from 90 to 99.5 wt. % (% by weight). Examples of alloying metals are copper, silver, indium, germanium, nickel, lead, bismuth and antimony. The alloys can contain lead or be lead-free. Lead-free alloys can be selected, for example, from the group consisting of SnAg, SnBi, SnSb, SnAgCu, SnCu, SnSb, InSnCd, InBiSn, InSn, BiSnAg or SnAgCuBiSbNi. Alloys containing lead can be selected, for example, from the group comprising SnPb and SnPbAg. The melting temperatures of the solders can be, for example, in the range from 150 to 500° C., in particular 170 to 350° C.

The term “sinter preform” used herein refers to sintering agents that are incompletely sintered, for example as sintered metal foil, but in particular dried and non-sintered or only partially sintered sintering paste. The sintering agent or the sintering paste can be a metal sintering agent or a metal sintering paste. The metal of the metal sintering agent or the metal sintering paste can in particular be copper or silver. In the case of the metal sintering paste, the copper or silver is usually present in particulate form.

The term “solder deposit” used herein refers to a solder that is firmly connected to the contact surface of an electronic component, which solder serves to be able to be firmly connected to the further electronic component via the contact surface thereof. A solder deposit located on an electronic component can typically be produced by melting a solder material applied to the contact surface of an electronic component, for example an applied solder paste or placed solder preform, or the solder metal it comprises, and subsequently cooling it with solidification of the solder metal. As stated, the solidified solder metal connected to the contact surface of the electronic component is referred to as a solder deposit. The solder deposit connected to the contact surface of the electronic component has an outwardly facing free contact surface and can thus function as a solder material serving to establish a solder connection to a further electronic component. For this purpose, it can be melted into molten solder in a furnace, for example a reflow oven, and, after leaving the furnace, cooling and solidification form the desired firm connection of the electronic components to one another.

The term “electronic component” used herein refers in each case to substrates which are common in electronics, and active or passive electronic components, which preferably cannot be dismantled further. The electronic components have contact surfaces, in particular metal contact surfaces.

Examples of substrates include IMS substrates (insulated metal substrates), AMB substrates (active metal brazed substrates), DCB substrates (direct copper bonded substrates), ceramic substrates, PCBs (printed circuit boards), and lead frames.

Examples of active electronic components comprise diodes, LEDs (light emitting diodes), dies (semiconductor chips), IGBTs (insulated-gate bipolar transistors), ICs (integrated circuits) and MOSFETs (metal-oxide-semiconductor field-effect transistors).

Examples of passive electronic components comprise sensors, baseplates, heat sinks, connecting elements (e.g. clips), resistors, capacitors, inductors, and antennas.

It is problematic that during movement or during transport of an arrangement which is not yet firmly interconnected, in any of the embodiments mentioned at the outset, for example during transport into a furnace, an undesired change in position between the preform(s) and the electronic component(s) may occur. The same is true in the case of movement or transport of an arrangement consisting of an electronic component equipped with a solder deposit, and a further electronic component to be connected thereto. In the worst case, an electronic component may not only be displaced with respect to the preform or the electronic component to be connected or with respect to a solder deposit, or assume a tilt, but rather can even detach and fall down. The causes can be, for example, vibrations or acceleration or braking processes during transport. In this case, the temporary fixing already described, by means of a temporary fixative, can provide relief here.

The object of the invention was to provide a temporary fixative which can be used in the above-mentioned sense in the electronics field, and has favorable viscosity behavior in the sense of the lowest possible tendency to flow after application. The temporary fixative to be found should have a high yield strength and thus allow it to be applied in a positionally and dimensionally stable manner. The viscosity behavior of the temporary fixative to be found is of particular importance when it is applied by means of a method which causes a shear stress, such as dispensing or jetting. After its application, the temporary fixative should remain as dimensionally and positionally stable as possible and thus contribute to the process reliability of a prefixing process carried out industrially using it. The temporary fixative to be found should moreover lead to the lowest possible wear of the tool or tools used for its application, which also contributes to the process reliability or stability. Furthermore, the temporary fixative to be found should not lead to damage to the surface coming into contact therewith, in particular not during its application.

The object can be achieved by providing a composition as described below. The invention therefore relates to a composition which can be used as a temporary fixative, in particular as a temporary fixative in the electronics field. It should be noted that the term “composition according to the invention” used herein means the temporary fixative in the original state, i.e. in the state before its application. By contrast, the term “temporary fixative” is used both as a designation for the original composition according to the invention and for a material formed therefrom during or after application, by a possible partial or complete loss of volatile substances. The volatile substances mentioned may in particular be organic solvent originally contained in the original composition according to the invention.

The composition according to the invention consists of:
(A) 20% to 30% by weight, preferably 22% to 28% by weight, of one or more thermoplastic polymers,
(B) 45% to 69% by weight, preferably 50% to 65% by weight, of organic solvent,
(C) 2% to 15% by weight, preferably 5% to 9% by weight, of silica particles,
(D) 0.5% to 10% by weight, preferably 1% to 4% by weight, of organic thickener,
(E) 1% to 10% by weight, preferably 5% to 8% by weight, of particulate inorganic filler having a Mohs hardness in the range from 1 to 8, and
(F) 0% to 1% by weight, preferably 0% to 0.5% by weight, of one or more constituents other than constituents (A) to (E).

In a preferred embodiment, the composition according to the invention consists of:
(A) 22% to 28% by weight of one or more thermoplastic polymers,
(B) 50% to 65% by weight of organic solvent,
(C) 5% to 9% by weight of silica particles,
(D) 1% to 4% by weight of organic thickener,
(E) 5% to 8% by weight of particulate inorganic filler having a Mohs hardness in the range from 1 to 8, and
(F) 0% to 0.5% by weight, in particular 0.1% to 0.5% by weight, of one or more constituents other than constituents (A) to (E).

The composition according to the invention comprises (A) 20% to 30% by weight, preferably 22% to 28% by weight, of one or more thermoplastic polymers. Examples comprise in each case thermoplastic polyesters, polyurethanes and (meth)acrylic copolymers, and also hybrids of these polymer types.

Preferred thermoplastic polymers are thermoplastic (meth)acrylic copolymers. “(Meth)acrylic” means “methacrylic” and/or “acrylic.” These are copolymers of (meth)acrylic compounds, it also being possible for the copolymers to be comonomers other than those of (meth)acrylic type, for example vinyl compounds, in a proportion by weight of overall <50% by weight, based on the total (meth)acrylic copolymer. Examples of the (meth)acrylic compounds which make up >50% by weight, based on total (meth)acrylic copolymer, are (meth)acrylic acid, (meth)acrylic acid esters and (meth)acrylamides. Examples of vinyl compounds comprise compounds such as vinyl ester, vinyl ether, styrene and the like.

Compositions according to the invention are preferred of which constituent (A) consists of one or more thermoplastic (meth)acrylic copolymers.

The thermoplastic polymer(s) can have a glass transition temperature for example in the range from 40 to 100° C. The glass transition temperature can be determined in accordance with DIN EN ISO 11357-1 by means of DSC (differential scanning calorimetry) at a heating rate of 10 K/minute.

Unless otherwise noted, all standards cited herein are in each case the current version at the time of the filing date.

The thermoplastic polymer(s) may have a weight-average molar mass Mw for example in the range from 30,000 to 180,000. The weight average of the molar mass Mw can be determined according to DIN 55672-1 by means of GPC (gel permeation chromatography, polystyrene standards, polystyrene gel as stationary phase, tetrahydrofuran as mobile phase).

The thermoplastic polymer(s) can be free of acidic groups or can comprise acidic groups corresponding to an acid number of for example <50 mg KOH/g, preferably <25 mg KOH/g, and in particular <10 mg KOH/g; they particularly preferably have no acidic groups and have no acid number. The term “acidic groups” used herein means functionalities that function as proton donors and can form H₃O⁺ ions in water, for example carboxyl groups, sulfonic acid groups, and the like.

The determination of the acid number, for example carboxyl number, of organic polymers is known to a person skilled in the art, for example the determination according to DIN EN ISO 2114.

The thermoplastic polymer(s) are soluble in the organic solvent (B); in other words, constituent (A) is present in the composition according to the invention dissolved in constituent (B).

The composition according to the invention comprises (B) 45% to 69% by weight, preferably 50% to 65% by weight, of organic solvent. The organic solvent(s) (B) is in particular organic solvent(s) that boil at ≤285° C. Examples include araliphatics such as toluene and xylene;

ketones such as methyl ethyl ketone and methyl isobutyl ketone; esters such as ethyl acetate, isobutyl acetate and dimethyl succinic esters, glycol ethers such as diethylene glycol monobutyl ether; alcohols such as benzyl alcohol, and more particularly terpineols.

The composition according to the invention comprises (C) 2% to 15% by weight, preferably 5% to 9% by weight, of silica particles. The silica particles serve as inorganic thickeners. The silica particles can have a specific surface area for example in the range from 50 to 500 m²/g. The specific surface area in m²/g can be determined by means of BET measurement according to DIN ISO 9277 (according to chapter 6.3.1, static volumetric measurement method, gas used: nitrogen). The silica particles can have an average particle size (d50) for example in the range from 5 to 50 nm.

The term “average particle size” used herein means the average particle diameter (d50) determinable by means of laser diffraction. Laser diffraction measurements can be carried out using a corresponding particle size measuring instrument, for example a Mastersizer 3000 from Malvern Instruments.

The composition according to the invention comprises (D) 0.5% to 10% by weight, preferably 1% to 4% by weight, of organic thickener. The organic thickener can be one or more different organic thickeners which are combined with one another, as are known to a person skilled in the art in particular as organic thickeners, organic anti-flow agents and/or as organic thixotropic agents for solvent-based non-aqueous coating agents. Examples comprise hydrogenated castor oil, modified fat derivatives, cellulose derivatives such as ethyl cellulose, diamides, polyamides, diureas and polyureas. Preferably, constituent (D) consists of one or more cellulose derivatives, in particular ethyl cellulose.

The organic thickener (D) can be soluble completely or colloidally in the organic solvent (B); in other words, constituent (D) can be present in the composition according to the invention completely or colloidally dissolved in constituent (B).

The composition according to the invention comprises (E) 1% to 10% by weight, preferably 5% to 8% by weight, of particulate inorganic filler having a Mohs hardness in the range from 1 to 8. The particulate inorganic filler can be particles of one or more different inorganic fillers, in each case having a Mohs hardness in the range from 1 to 8. Particles of inorganic fillers having a Mohs hardness in the range from 1 to 6, in particular in the range from 1 to 4, are preferred. Examples of suitable inorganic fillers comprise zirconium silicate, quartz, titanium dioxide, mica, calcium silicate, kaolin and α-boron nitride. α-boron nitride is a particularly preferred example and can also be contained as the sole inorganic filler of the type (E) in the composition according to the invention. The inorganic filler(s) are present as particles, the average particle size (d50) of which can be for example in the range from 5 to 20 μm, preferably 5 to 10 μm.

Constituent (E) does not comprise any silica particles.

The composition according to the invention can comprise (F) 0% to 1% by weight, preferably 0% to 0.5% by weight, of one or more constituents other than constituents (A) to (E). Examples comprise dyes and additives, as are known to a person skilled in the art, in particular as additives for solvent-based non-aqueous coating agents. In particular, additives influencing the surface tension, such as wetting additives, are to be mentioned here. Preferably, constituent (F), and thus also the composition according to the invention, does not comprise any aluminum oxide particles.

The composition according to the invention can be prepared by mixing the constituents (A) to (E) or (A) to (F).

The viscosity behavior of the composition according to the invention can of course be influenced by all its constituents. However, it has been shown to be essential that the composition according to the invention comprises the constituents (C) and (D) simultaneously.

The composition according to the invention is characterized by a high yield strength T₀ over a relevant temperature range, for example from 20 to 80° C. Thus, the yield strength T₀ of the composition according to the invention at 23° C. is for example in the range from 200 to 300 Pa, at 50° C. for example in the range from 90 to 200 Pa, and at 75° C. for example in the range from 40 to 100 Pa. The determination of the yield strength T₀ at a corresponding temperature can take place for example by means of rotary viscometry, for example using the plate-cone measuring principle at a cone diameter of 25 mm and a cone angle of 2° with a measuring gap of 104 μm and, for example, with a shear rate that increases uniformly over the range from 0.05 to 50 s 1 within 15 minutes.

The composition according to the invention or the temporary fixative is sticky, i.e. also under the conditions of use as a temporary fixative, that is to say during application and also in the creation of a temporarily fixed arrangement, thus for example in the temperature range from 60 to 130° C. The factors which significantly influence the adhesive effect in this phase are the glass transition temperature of the thermoplastic polymer(s) (A) and the proportion of the organic solvent(s) (B).

The composition according to the invention can be used successfully as a temporary fixative, in particular in the electronics field.

The composition according to the invention can be used for temporarily fixing an arrangement which is not yet firmly connected, consisting of one or more electronic components with one or more solder or sinter preforms. For example, the composition according to the invention can be used for temporarily fixing a solder preform to be converted into a solder deposit, or a sinter preform, on an electronic component; the temporarily fixed arrangement then comprises or consists of an electronic component and a solder preform to be converted into a solder deposit, or of an electronic component and a sinter preform, in each case having the temporary fixative in between. The composition according to the invention can further be used for temporarily fixing solder or sinter preforms between electronic components; the temporarily fixed arrangement can then comprise or consist of electronic components with a solder or sinter preform located therebetween and with the temporary fixative between the preform and at least one of the electronic components.

However, the composition according to the invention can also be used for temporarily fixing an electronic component to a further electronic component equipped with a solder deposit; the temporarily fixed arrangement then comprises or consists of a first electronic component, which is located on a solder deposit of a further electronic component equipped therewith, with the temporary fixative between the first electronic component and the solder deposit or, more precisely, between the first electronic component and the originally outwardly facing free contact surface of the solder deposit of the further electronic component.

The composition according to the invention can further be used to equip a solder deposit located on an electronic component with temporary fixative on its outwardly facing free contact surface.

In all the types of use mentioned above, the composition according to the invention or the temporary fixative is applied to at least one contact surface. Possible contact surfaces are those of the electronic components, but also those of said solder or sinter preforms or also an outwardly facing free contact surface of a solder deposit.

In all the types of use mentioned above, the composition according to the invention can be applied by means of various application techniques, for example by dipping, dispensing or jetting, in particular by dispensing or jetting. As already stated, in this case the application site or application sites are said contact surfaces.

The composition according to the invention is expediently applied in the heated state, for example at a temperature in the range from 45 to 75° C., i.e. the composition according to the invention leaves the application tool heated to the temperature in question. As already mentioned at the outset, the composition according to the invention is also sheared during application by means of the preferred dispensing or jetting.

Especially in the case of application by means of the preferred dispensing or jetting, there is a favorable behavior of the composition according to the invention; it thus leads to only low wear of the corresponding application tools. For example, the replacement of wearing parts such as a nozzle, a ram or a screw dosing valve is required only after a relatively long use period.

The composition according to the invention can be applied for example in a bar-like manner to the side of a preform, but in particular in the form of points, for example hemispherical or hemisphere-like points. The height of the points immediately after application can be in the range of 50 to 80 μm, for example. Their diameter immediately after application can be in the range of 200 to 1000 μm, for example.

On the route from the application tool to the application site, the composition according to the invention used as temporary fixative may lose part of the originally contained organic solvent (B) due to evaporation losses. The application of the composition according to the invention can initially be followed by drying for the purpose of partial or complete removal of the organic solvent (B) contained. However, it is also possible to work in such a way that, following the application of the composition according to the invention, the desired temporarily fixed arrangement is first produced according to one of the aforementioned embodiments, and the drying is carried out subsequently. The drying can be carried out for example at 90 to 150° C. object temperature for 2 to 30 minutes. It is also possible to carry out no drying, i.e. to permit passive drying without actively taking measures for drying.

As can already be seen from the above-mentioned statements regarding the adhesive effect, the proportion of the organic solvent(s) (B) is a factor that significantly influences the adhesive effect. A person skilled in the art can influence the adhesive effect via the selection of the drying parameters. The temperature conditions under which the temporarily fixed arrangements are transported and/or stored are furthermore taken into account. In general, this occurs in a temperature range for example from 18 to 28° C. A person skilled in the art will apply the same considerations for electronic components equipped with a solder deposit, which are equipped with temporary fixative on the outwardly facing free contact surface of the solder deposit.

As a result of the use of the composition according to the invention as a temporary fixative in the electronics field, the invention also relates to electronic components equipped with a solder deposit, which are equipped on the outwardly facing free contact surface of the solder deposit with the temporary fixative applied, consisting of the composition according to the invention. In this case, the organic solvent (B) originally contained in the composition according to the invention can be completely present or usually partially or completely removed in the temporary fixative.

As further results of the use of the composition according to the invention as a temporary fixative in the electronics field, the invention relates to temporarily fixed arrangements according to all the embodiments explained above. The following examples (1) to (5) are in particular included in this case:
(1) Temporarily fixed arrangement consisting of an electronic component and a solder preform with an applied temporary fixative located therebetween consisting of a composition according to the invention.
(2) Temporarily fixed arrangement consisting of an electronic component and a sinter preform with an applied temporary fixative located therebetween consisting of a composition according to the invention.
(3) Temporarily fixed arrangement consisting of electronic components with one or more sinter preforms located therebetween and applied temporary fixative between at least one of the electronic components and the or at least one of the sinter preforms, consisting of a composition according to the invention.
(4) Temporarily fixed arrangement consisting of electronic components with one or more solder preforms located therebetween and applied temporary fixative between at least one of the electronic components and the or at least one of the solder preforms, consisting of a composition according to the invention.
(5) Temporary fixed arrangement consisting of a first electronic component, which is located on a solder deposit of a further electronic component equipped therewith, with an applied temporary fixative consisting of a composition according to the invention, between the first electronic component and the solder deposit.

In this case, the organic solvent (B) originally contained in the composition according to the invention can be completely present or usually partially or completely removed in the temporary fixative, in all temporarily fixed arrangements of examples (1) to (5).

For the purpose of transferring from the temporarily fixed state into a firmly connected state by soldering or sintering, a temporarily fixed arrangement such as one according to the aforementioned examples (1) to (5) can finally be subjected to a corresponding heat or temperature treatment. In the course of the heat or temperature treatment, the temporary fixative can be removed apart from a remainder of non-disruptive inorganic residues in the form of silica and inorganic filler particles.

### EXAMPLES

In order to produce temporary fixative by way of example, thermoplastic (meth)acrylic copolymer, α-terpineol and ethyl cellulose were mixed in the quantitative ratios indicated in Table 1 at 70 to 80° C. until all the constituents were dissolved. Subsequently, inorganic filler and silica particles were added while stirring and allowed to swell at 70 to 80° C. for 10 minutes. The temporary fixatives exhibited Casson's flow behavior.

The yield strength T₀ at three different temperatures (23° C., 50° C. and 75° C.) was determined by means of a rheometer (Physica/MCR 301, plate-cone measuring principle, cone diameter of 25 mm, cone angle of 2°, measuring gap of 104 μm, viscosity measurement with a shear rate increasing uniformly over the range from 0.05 to 50 s 1 within 15 minutes).

TABLE 1
Composition of temporary fixatives according to the invention
(E1 and E2) and three comparative examples (V1, V2 and V3)

| Composition, all figures in % by weight | E1 | E2 | V1 | V2 | V3 |
|---|---|---|---|---|---|
| Thermoplastic (meth)acrylic copolymer | 28 | 25 | 27 | 22 | 25 |
| (Mw 70,000, acid number 7 mg KOH/g, | | | | | |
| Tg 60° C.) | | | | | |
| α-Terpineol | 55 | 59 | 59 | 64 | 65 |
| Silica particles (d50 = 20 nm) | 7 | 7 | 7 | 7 | — |
| Ethyl cellulose | 2 | 2 | — | — | 4 |
| α-boron nitride particles (d50 = 6 μm) | 8 | — | — | 7 | 6 |
| Calcium silicate particles (d50 = 4.5 μm) | — | 7 | — | — | — |
| Aluminum oxide particles (d50 = 7 μm) | — | — | 7 | — | — |
| Yield strength τ₀ (Pa) at 23° C. | 265 | 263 | 26 | 29 | 101 |
| Yield strength τ₀ (Pa) at 50° C. | 127 | 118 | 25 | 0 | 9 |
| Yield strength τ₀ (Pa) at 75° C. | 80 | 74 | 20 | 0 | 0.6 |

The temporary fixatives E1 and E2 according to the invention allowed a higher number of dispensing operations until the screw dosing valve in the dispenser became worn, than was the case for the comparative compositions V1-V3.

1. A composition consisting of:
(A) 20% to 30% by weight of one or more thermoplastic polymers;
(B) 45% to 69% by weight of organic solvent;
(C) 2% to 15% by weight of silica particles;
(D) 0.5% to 10% by weight of organic thickener;
(E) 1% to 10% by weight of particulate inorganic filler having a Mohs hardness in the range from 1 to 8; and,
(F) 0% to 1% by weight of one or more constituents other than constituents (A) to (E).

2. The composition according to claim 1, consisting of:
(A) 22% to 28% by weight of one or more thermoplastic polymers;
(B) 50% to 65% by weight of organic solvent;
(C) 5% to 9% by weight of silica particles;
(D) 1% to 4% by weight of organic thickener;
(E) 5% to 8% by weight of particulate inorganic filler having a Mohs hardness in the range from 1 to 8; and,
(F) 0% to 0.5% by weight of one or more constituents other than constituents (A) to (E).

3. The composition according to claim 1, wherein the thermoplastic polymer(s) are selected from the group consisting of thermoplastic polyesters, thermoplastic polyurethanes, thermoplastic (meth)acrylic copolymers and thermoplastic hybrids of these polymer types.

4. The composition according to claim 1, wherein the particulate inorganic filler(s) of constituent (E) are selected from the group consisting of zirconium silicate, quartz, titanium dioxide, mica, calcium silicate, kaolin and α-boron nitride.

5. The composition according to claim 4, wherein constituent (E) is α-boron nitride.

6. A use of the composition according to claim 1 as a temporary fixative in the electronics field.

7. The use according to claim 6 for temporarily fixing an arrangement, which is not yet firmly connected, consisting of one or more electronic components with one or more solder or sinter preforms, or for temporarily fixing an electronic component on a further electronic component equipped with a solder deposit.

8. A use of the composition according to claim 1 for equipping a solder deposit located on an electronic component with temporary fixative on its outwardly facing free contact surface.

9. The use according to claim 6, wherein the composition is applied by dipping, dispensing or jetting.

10. The use according to claim 9, wherein the composition is applied at a temperature in the range from 45 to 75° C.

11. An arrangement, which is not yet firmly connected, obtainable as a result of the use according to claim 7 and consisting of one or more electronic components with one or more solder or sinter preforms, or an electronic component which is obtainable as a result of said use and is temporarily fixed on a further electronic component equipped with a solder deposit.

12. An electronic component equipped with a solder deposit, which is obtainable as a result of the use according to claim 8 and is equipped with the temporary fixative on the outwardly facing free contact surface of the solder deposit.
